(19) United States
(12) Patent Application Publication
(10) Pub. No.: US 2019/0283233 A1
(43) Pub. Date: Sep. 19, 2019

(54) Socket Holding Device

(71) Applicant: GRIP HOLDINGS LLC, Brandon, FL (US)

(72) Inventors: Thomas Stefan Kukucka, Brandon, FL (US); Paul Kukucka, Brandon, FL (US)

(21) Appl. No.: 16/284,558

(22) Filed: Feb. 25, 2019

Related U.S. Application Data
(63) Continuation-in-part of application No. PCT/IB2018/060749, filed on Dec. 31, 2018.
(60) Provisional application No. 62/643,443, filed on Mar. 15, 2018.

(51) Int. Cl. B25H 3/00; B25H 3/06

(52) U.S. Cl. CPC B25H 3/003; B25B 13/56; B65D 2313/04; B25H 3/06

(57) ABSTRACT

A holding device for wrench sockets that provides additional securing means for the sockets. The holding device includes a planar housing and an at least one socket-attachment mechanism. The planar housing acts as a structural support element for sockets. The socket-attachment mechanism includes an at least one magnet and an at least one socket-engaging feature. The socket-attachment mechanism is integrated into the planar housing to attach sockets to the planar housing. The magnet extends from a first end of the planar housing to a second end of the planar housing to magnetically secure the sockets to the planar housing. Additionally, the magnet is internally mounted within the planar housing. The socket-engaging feature is preferably a plurality of socket-engaging features, wherein the socket-engaging features are distributed along the planar housing to interlock with sockets. Each of the plurality of socket-engaging features is integrated into a top surface of the planar housing.

### FIELD OF THE INVENTION

The present invention relates generally to a storage apparatus. More specifically, the present invention is a storage apparatus that utilizes magnetics and mounting means to retain a ferromagnetic implement such as a socket tool.

### BACKGROUND OF THE INVENTION

Presently, storages particularly those suited for holding the sockets of a conventional ratchet set or similar is restricted to the one a user receives at the purchase of the particular socket set, or elsewise providing a disadvantageous surplus of storage space, where in either instance the sockets are subject to becoming dislodged the greater the angle to the horizontal the storage achieves. The present invention seeks to surmount these issues by offering a body with a plurality of studs on a first plate that protrude upward with a unique cylindrical and domed geometry to suit any size or geometry of an extraneous socket to address the first issue. Simultaneously, the present invention provides a unique plurality of magnets in an array that in a particular configuration as to provide a magnetic field that cancels out through alternating north and south upward facing magnets that may dampen the magnetic field outside the proximity allotted to the extraneous socket, thereby limiting the attraction to extraneous ferromagnetic particles. Thus, the present invention both provides an all in one storage for socket or similar ferromagnetic implements while providing a retaining means that is native to the apparatus without limiting the user's ability to retrieve an extraneous socket from the storage apparatus, with the additional feature of limiting undesirable extraneous ferromagnetic particles that can impede the functions of the apparatus.

### BRIEF DESCRIPTION OF THE DRAWINGS

FIG. 1 is a perspective view of the present invention.

FIG. 2 is a cross-sectional view of the present invention.

FIG. 3 is a cross-sectional view of an alternative embodiment of the present invention.

FIG. 4 is a perspective view of an alternative embodiment of the present invention.

FIG. 5 is a perspective view of an alternative embodiment of the present invention.

FIG. 6 is a top view of the alternative embodiment of the present invention.

FIG. 7 is a perspective view of an alternative embodiment of the present invention.

FIG. 8 is a top view of the alternative embodiment of the present invention.

FIG. 9 is a perspective view of an alternative embodiment of the present invention.

FIG. 10 is a top view of an alternative embodiment of the present invention.

FIG. 11 is a perspective view of an alternative embodiment of the present invention.

### DETAIL DESCRIPTIONS OF THE INVENTION

All illustrations of the drawings are for the purpose of describing selected versions of the present invention and are not intended to limit the scope of the present invention.

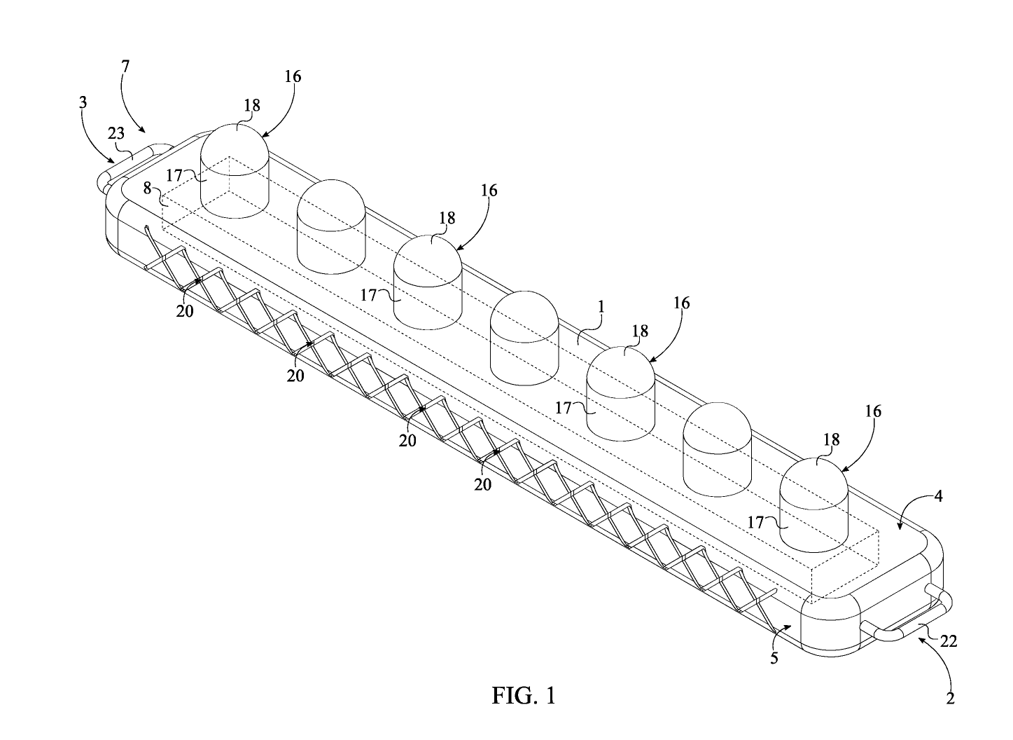

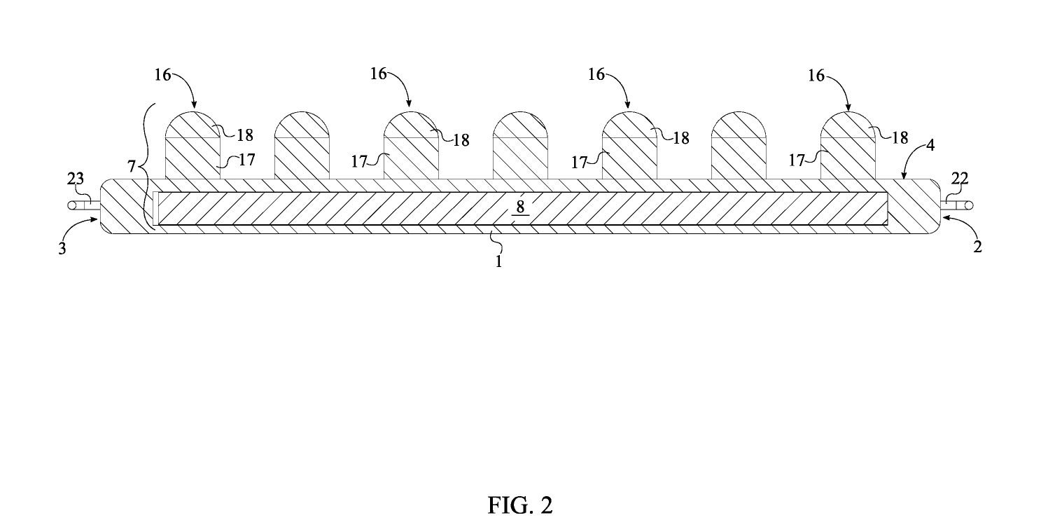

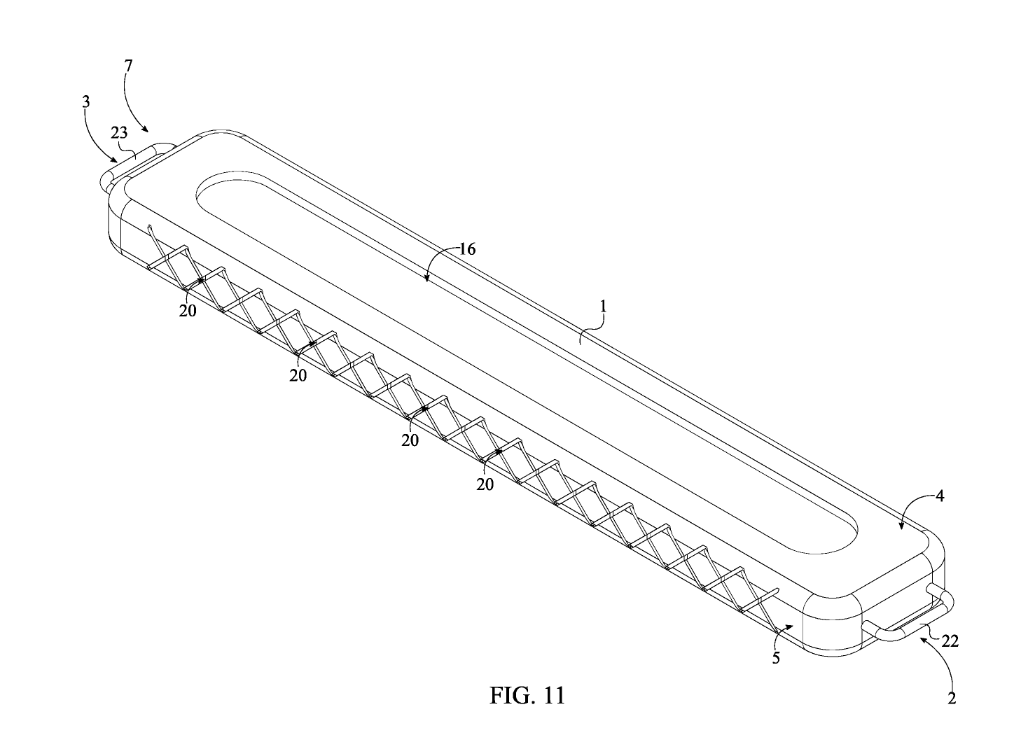

The present invention is a tool holding device. More specifically, the present invention is a socket holding device. Referring to FIG. 1 and FIG. 2, the present invention comprises a planar housing 1 and an at least one socket-attachment mechanism 7. The planar housing 1 is an elongated flat structure that acts as the base and support structure. The preferred planar housing 1 is an elongated rectangular extrusion with a first end 2 and a second end 3. The corners and sides of the planar housing 1 may be rounded to increase the ease of use for the user. The socket-attachment mechanism 7 physically and magnetically supports and retains an at least one socket, also known as a wrench socket. In general, the socket-attachment mechanism 7 attaches socket(s) to the planar housing 1 and is thus integrated into the planar housing 1. Referring to FIG. 11, the socket-attachment mechanism 7 comprises an at least one magnet 8 and an at least one socket-engaging feature 16. The magnet 8 creates a magnetic field around the planar housing 1 to magnetically attach the socket(s) to the planar housing 1. The magnet 8 is internally mounted within the planar housing 1 and extends from the first end 2 of the planar housing 1 to the second end 3 of the planar housing 1. The socket-engaging feature 16 physically interlocks with a socket for a physical attachment. The socket-engaging feature 16 is positioned adjacent to a top surface 4 of the planar housing 1 and is integrated into the planar housing 1. In the preferred embodiment, the at least one socket-engaging feature 16 is a plurality of socket-engaging features 16. The plurality of socket-engaging features 16 is distributed along the magnet to ensure a magnetic and physical attachment means for the socket(s). To attach the socket(s) to the planar housing 1, the plurality of socket-engaging features 16 is positioned adjacent to the top surface 4 of the planar housing 1. Additionally, each of the plurality of socket-engaging features 16 is integrated into the planar housing 1.

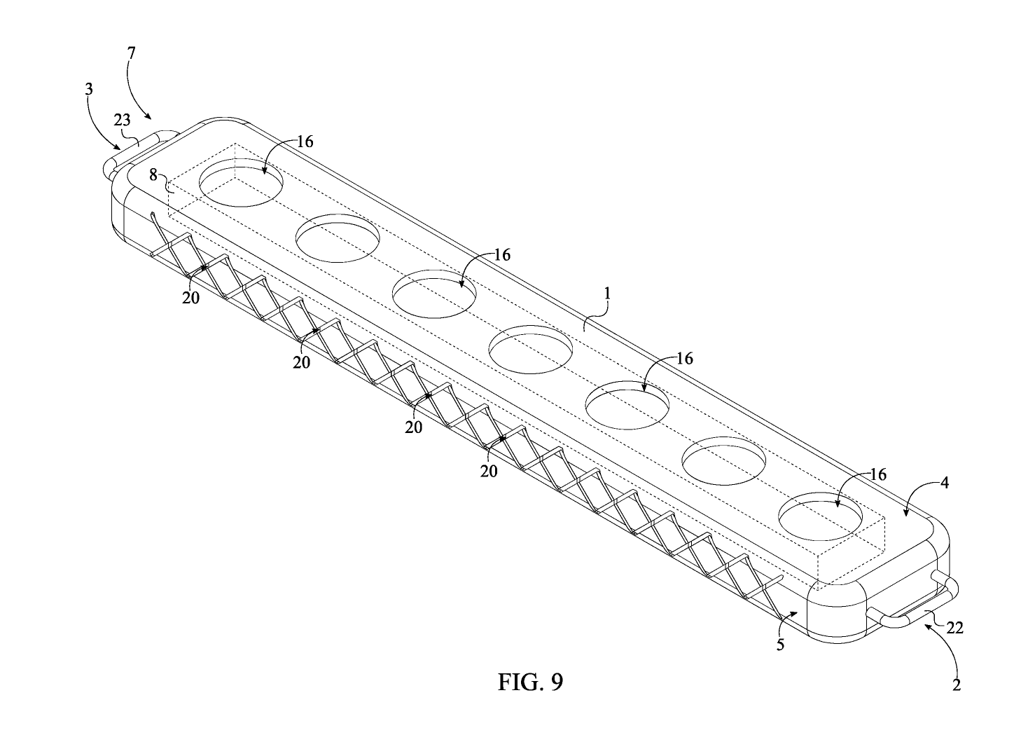

Referring to FIG. 9, in one embodiment of the present invention, each of the plurality of socket-engaging features 16 is a recessed region. The recessed region receives a portion of the socket and prevents the socket from laterally translating. Specifically, the recessed region normally traverses into the planar housing 1 from the top surface 4. The depth, size, and shape of the recessed region is subject to change to fit different types of sockets. Traditionally, sockets use a cylindrical body and thus, in one embodiment, a cross-section of the recessed region is a circular profile. In addition to interlocking with the socket, the recessed region positions the socket closer to the magnet 8 for a more secure magnetic attachment. In one embodiment of the present invention, a single socket-engaging feature 16 is used as seen in FIG. 11. In this embodiment, the recessed region extends along the planar housing 1.

Referring to FIG. 2, in the preferred embodiment of the present invention, each of the plurality of socket-engaging features 16 comprises a stud 17 and a dome 18. The stud 17 and the dome 18 act as shank upon which the socket is sleeved over for an interlocking engagement. The stud 17 acts as the structural body while the dome 18 increases the ergonomic as well as ease of use aspect of the stud 17. It is preferred that the stud 17 is a cylinder, although alternative geometries may also be utilized such as a square cross-section. The stud 17 is oriented normal to the top surface 4. Additionally, the stud 17 is adjacently connected to the top surface 4. The dome 18 is positioned adjacent to the stud 17, opposite the planar housing 1. Additionally, the dome 18 is concentrically and terminally connected to the stud 17. The dome 18 rounds out a free end of the stud 17 to smoothen the action of placing the socket over the stud 17, thus yielding a more efficient design. The diameter and height of the stud 17 are subject to change to fit different sizes and designs of sockets. Additionally, in one embodiment, the stud 17 is tapered from the planar housing 1 towards the dome 18. Additionally, the curvature of the dome 18 is preferably sized complimentary to the diameter of the stud 17. In another embodiment of the present invention, the stud 17 and the dome 18 may be removable, thus increasing the versatility of the present invention.

The present invention further comprises a first handle 22 and a second handle 23 for handling purposes. The first handle 22 and the second handle 23 are each preferably a U-shaped structure that act as grasping elements for present invention. The first handle 22 and the second handle 23 are not limited to a U-shaped structure and may be a partially circular shape, ring shape, or any other ergonomic shape which may easily conform to a finger or hand for ease of use. Additionally, the first handle 22 and the second handle 23 may be optionally removable if preferred by the user. This provides a user a means for handling the present invention. The first handle 22 is positioned adjacent to the first end 2 of the planar housing 1 and is laterally and pivotably connected to the planar housing 1. Similarly, the second handle 23 is positioned adjacent to the second end 3 of the planar housing 1 and is laterally and pivotably mounted to the planar housing 1. This provides the user with the ability to retract or extend the first handle 22 and or the second handle 23 for storage or management purposes. The pivot junction may be achieved through a pivoting mechanism such as but not limited to a pin and hinge mechanism. This allows the user to extend the first handle 22 and the second handle 23 away from the planar housing for additional ease of use and management of the present invention. Additionally, the first handle 22 and the second handle 23 are also useful as a means of pulling or lifting the present invention when the present invention is placed and magnetized to a ferrous surface.

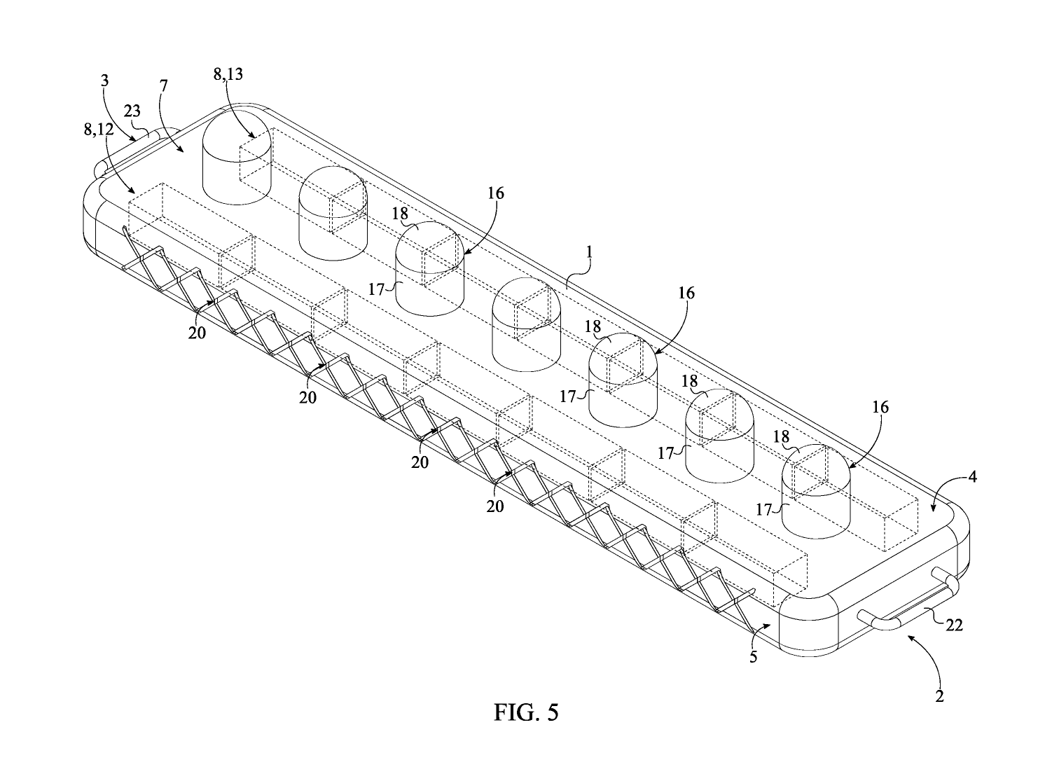

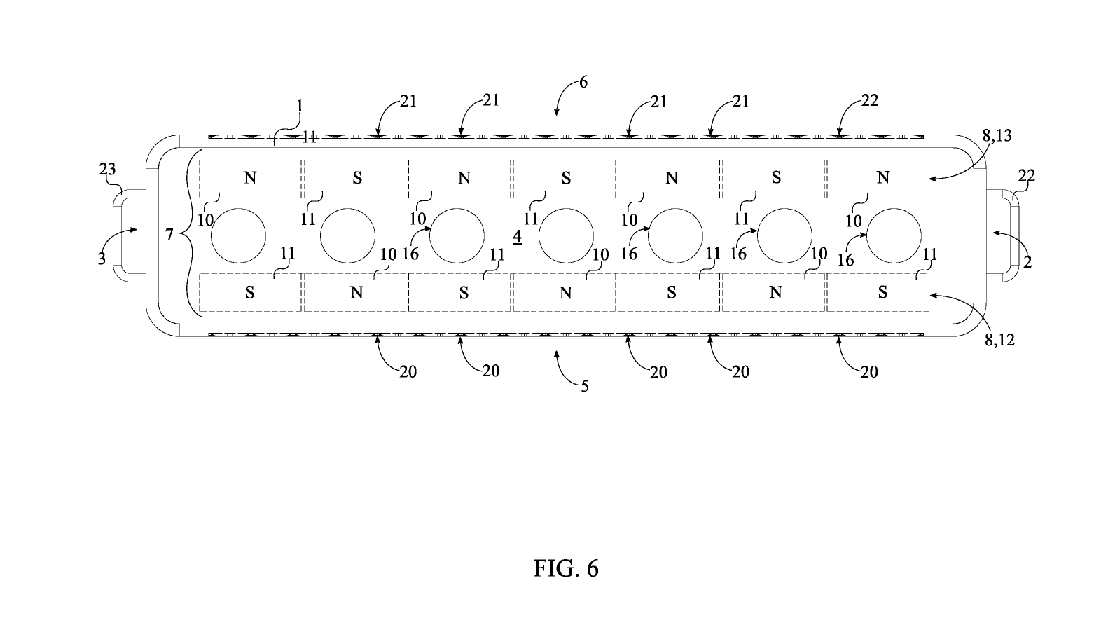

Referring to FIG. 5 and FIG. 6, to further ease handling and managing of the planar house, the present invention may also comprise a plurality of first gripping features 20 and a plurality of second gripping features 21. The plurality of first gripping features 20 extends from the first end 2 to the second end 3 to provide gripping action to the user all along the planar housing 1. The plurality of first gripping features 20 is positioned adjacent to a first lateral sidewall 5 of the planar housing 1. Additionally, each of the plurality of first gripping features 20 is integrated into the planar housing 1. Similarly, the plurality of second gripping features 21 extends from the first end 2 to the second with the plurality of second gripping features 21 being positioned adjacent to a second lateral sidewall 6. Resultantly, the plurality of first gripping features 20 and the plurality of second gripping features 21 are positioned opposite to each other across the planar housing 1. This provides symmetrical gripping action to the user. Additionally, each of the plurality of second gripping features 21 is integrated into the planar housing 1. In the preferred embodiment, each of the plurality of first gripping features 20 and each of the plurality of second gripping features 21 is a slot that traverses into the planar housing 1. Resultantly, the plurality of first gripping features 20 forms a knurling on the first lateral sidewall 5. Similarly, the plurality of second gripping features 21 forms a knurling on the second lateral sidewall 6. In another embodiment of the present invention, each of the plurality of first gripping features 20 and each of the plurality of second gripping features 21 is a protrusion.

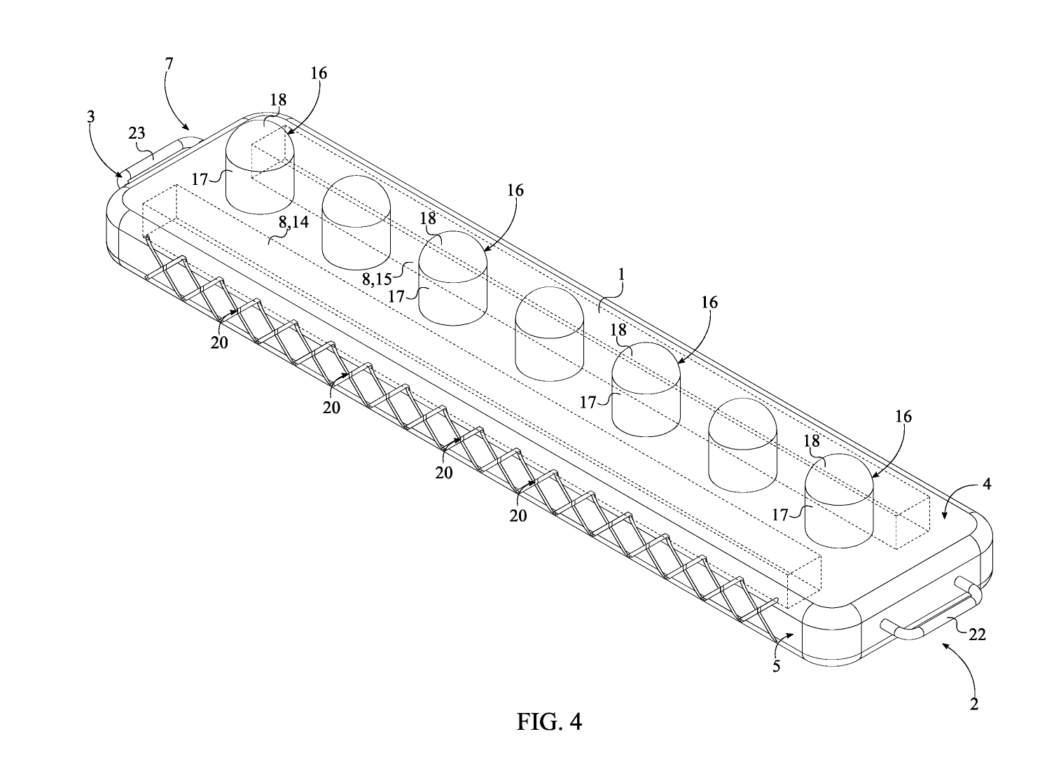

Referring to FIG. 4 and FIG. 5, in one embodiment of the present invention, the at least one magnet 8 comprise a first continuous magnet 14 and a second continuous magnet 15. The first continuous magnet 14 and the second continuous magnet 15 each span the length of the planar housing 1 and are positioned offset to each other. Additionally, the plurality of socket-engaging features 16 is positioned in between the first continuous magnet 14 and the second continuous magnet 15. This configuration ensures that the magnetic field about the plurality of socket-engaging features 16 is strong but the magnetic field laterally surrounding the planar housing 1 weak due to the configuration of the first continuous magnet 14 and the second continuous magnet 15. For this, the first continuous magnet 14 and the second continuous magnet 15 are oriented reverse of each other. Specifically, a north pole of the first continuous magnet 14 is positioned adjacent to the top surface 4 of the planar housing 1 and a south pole of the second continuous magnet 15 is positioned adjacent to the top surface 4 of the planar housing 1. Resultantly, the magnetic force about the plurality of socket-engaging features 16 is strong and the magnetic force laterally surrounding the planar housing 1 is partially cancelled out and or dampened to a high degree.

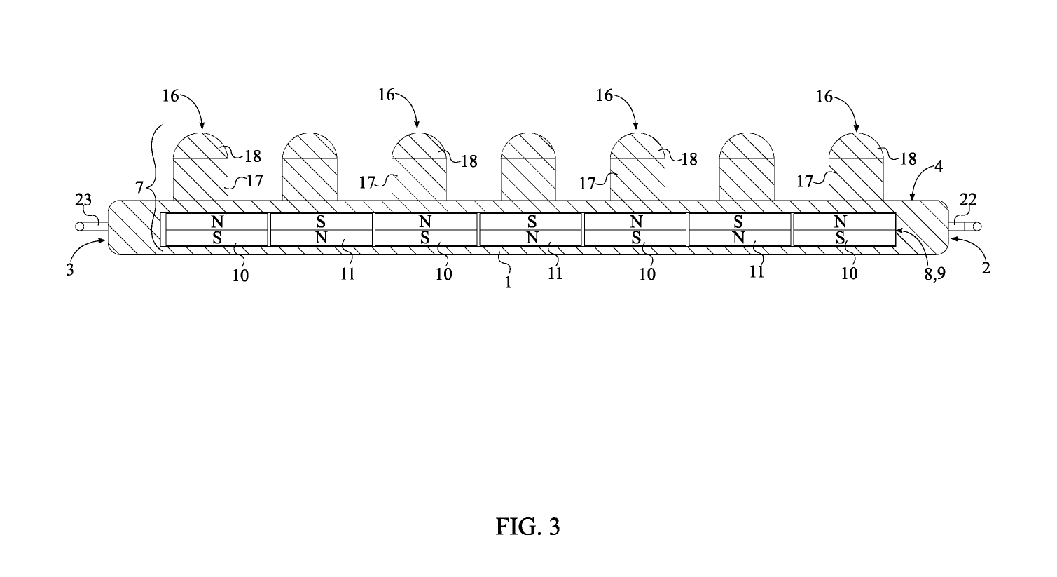

Referring to FIG. 3, in other embodiments of the present invention, the at least one magnet 8 comprises an at least one magnet assembly 9. The magnet assembly 9 is a set of magnets that are linearly aligned with alternating pole configurations. Specifically, the magnet assembly 9 comprises a plurality of first magnets 10 and a plurality of second magnets 11. Complimentary to the plurality of socket-engaging features 16, the plurality of first magnets 10 and the plurality of second magnets 11 are distributed along the planar housing 1 from the first end 2 to the second end 3. To yield a strong magnetic field about the plurality of socket-engaging features 16, the plurality of first magnets 10 is interspersed amongst the plurality of second magnets 11 with alternating pole configurations. In particular, a north pole for each within of the plurality of first magnets 10 is oriented towards the top surface 4; and a south pole for each within the plurality of second magnets 11 is oriented towards the top surface 4. In this embodiment, it is preferred that the plurality of socket-engaging features 16 is positioned directly overlapping the plurality of first magnets 10 and the plurality of second magnets 11.

Referring to FIG. 5 and FIG. 6, in the preferred embodiment of the present invention, the at least one magnet assembly 9 comprises a first magnet assembly 12 and a second magnet assembly 13. The first magnet assembly 12 and the second magnet assembly 13 are positioned offset to each other; wherein the plurality of socket-engaging features 16 being positioned in between the first magnet assembly 12 and the second magnet assembly 13. Additionally, the first magnet assembly 12 and the second magnet assembly 13 are offset along the length of the planar housing 1. Specifically, each of the plurality of first magnets 10 from the first magnet assembly 12 is positioned adjacent to a corresponding second magnet from the plurality of second magnets 11 of the second magnet assembly 13. Similarly, each of the plurality of second magnets 11 from the first magnet assembly 12 is positioned adjacent to a corresponding first magnet from the plurality of first magnets 10 of the second magnet assembly 13. Resultantly, an alternating polarity is created from the first lateral sidewall 5 to the second lateral sidewall 6. The preferred shape for each within the first plurality of first magnets 10 and each within the plurality of second magnets 11 is a cuboid. The first magnet assembly 12 and the second magnet assembly 13 may be sealed within the planer housing 1.

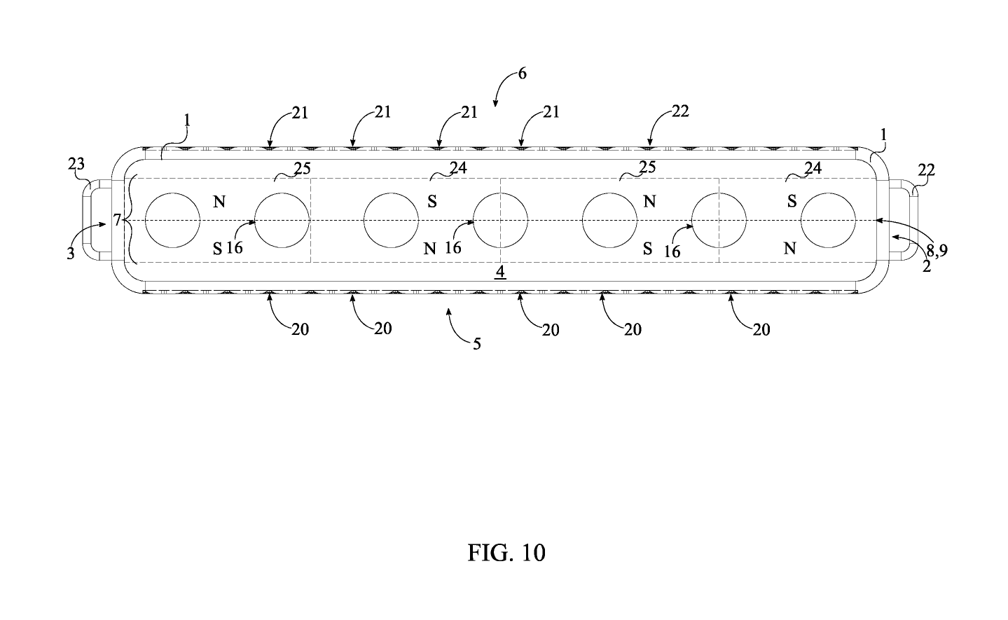

Referring to FIG. 10, in yet another embodiment of the present invention, the at least one magnet assembly 9 comprises a plurality of third magnets 24 and a plurality of fourth magnets 25. The plurality of third magnets 24 and the plurality of fourth magnets 25 are distributed along the planar housing 1 to yield a magnetic field along the whole length of the planar housing 1. Each within the plurality of third magnets 24 and each within the plurality of fourth magnets 25 is positioned with the poles oriented towards the first lateral sidewall 5 and the second lateral sidewall 6. More specifically, a north pole for each within the plurality of third magnets 24 is oriented towards the first lateral sidewall 5. Complimentary to this, a north pole for each within the plurality of fourth magnets 25 is oriented towards the second lateral sidewall 6. For maximum lateral dampening of magnetic fields about the planar housing 1, the plurality of third magnets 24 is interspersed amongst the plurality of fourth magnets 25.

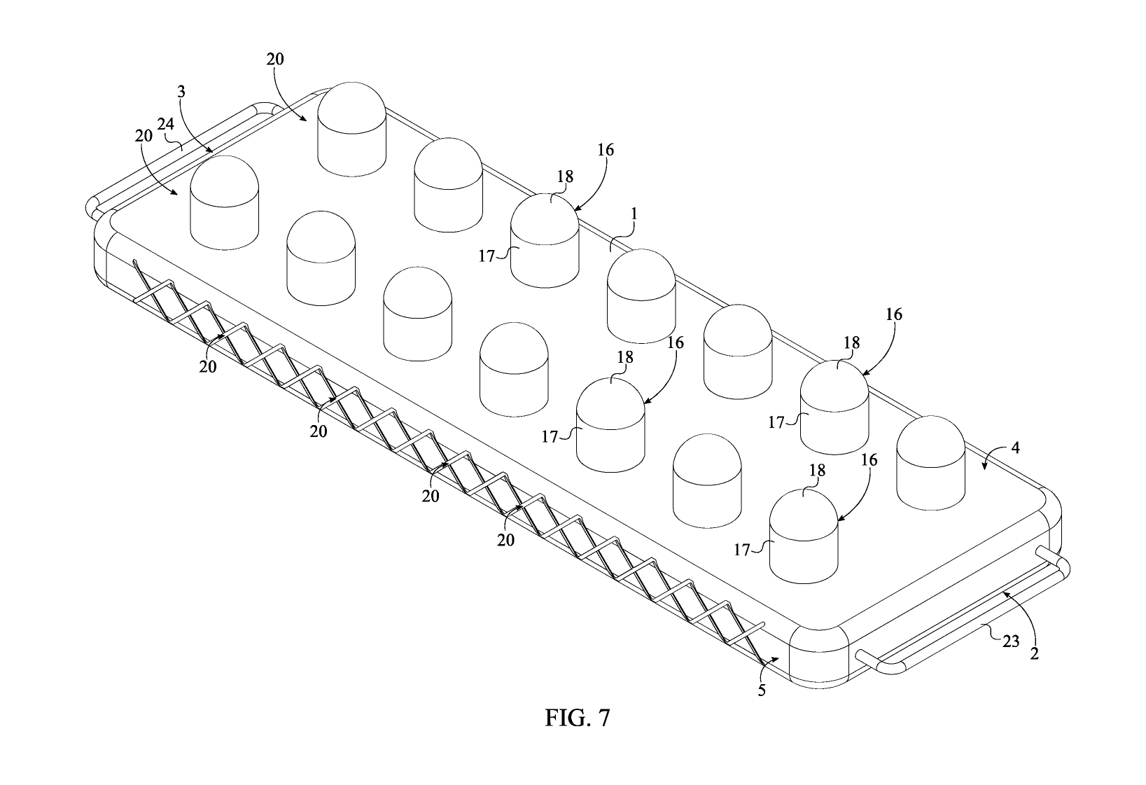

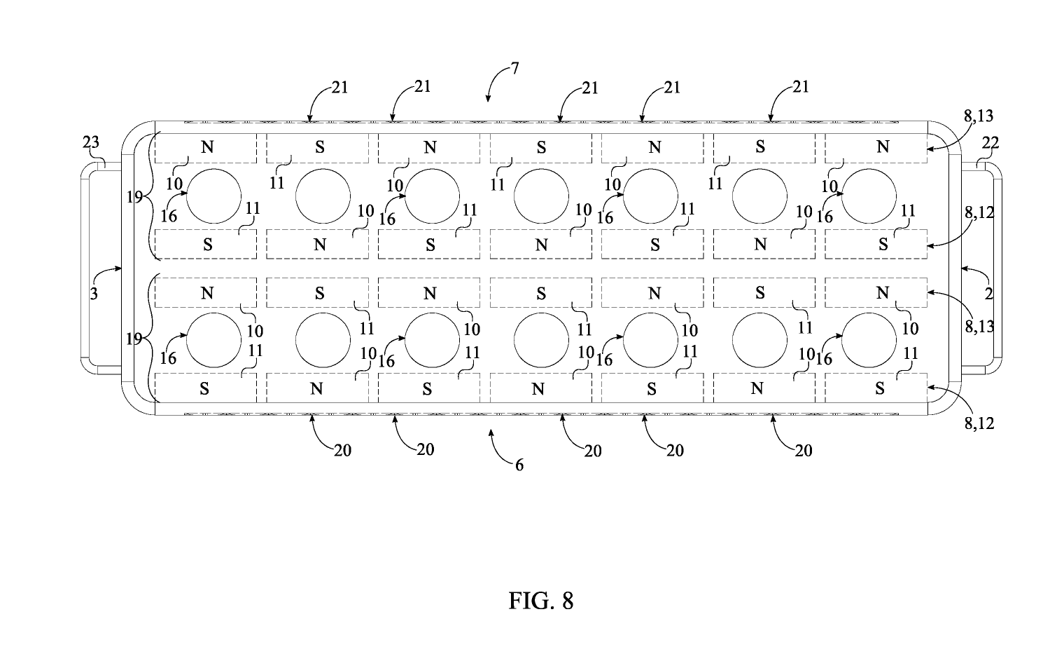

Referring to FIG. 7 and FIG. 8, to store and accommodate more sockets on the planar housing 1, the at least one socket-attachment mechanism 7 comprises a plurality of socket-attachment mechanisms 19. In particular, the plurality of socket-attachment mechanisms 19 is distributed about the planar housing 1 from the first lateral sidewall 5 to the second lateral sidewall 6. The number within the plurality of socket-attachment mechanisms 19 is subject to change to meet the needs and preferences of the user.

To mount the magnet 8 or the magnet assembly 9 within the planar housing 1, an at least one internal channel may be used. The internal channel extends from the first end 2 to the second end 3 and is integrated within the planar housing 1. The internal channel maybe rectangular in shape. The magnet 8 or the magnet assembly 9 is positioned within the internal channel. In one embodiment of the present invention, the planar housing 1 is molded around the magnet 8 or the magnet assembly 9. In another embodiment of the present invention, the planar housing 1 is molded/manufactured with the internal channel as a recessed region; wherein the internal channel normally traverses into a bottom surface of the planar housing 1 and a friction fitted cover is sized to close off an opening of the internal channel. This allows for the attachment of the magnet 8 or the magnet assembly 9 within the planar housing 1 through the internal channel and the cover.

In one embodiment, the present invention is implemented as a disk. In this embodiment, the planar housing 1 is a disk-shaped structure. In this embodiment, the at least one magnet 8 is a disk magnet sized to cover the whole planar housing 1. The plurality of socket-engaging features 16 is radially distributed about the disk-shaped structure. It is preferred that the material of the planar housing 1 is nonferrous. In yet another embodiment of the present invention, the at least one magnet 8 comprises a plurality of disk magnets. For this, the plurality of disk magnets mirrors the plurality of socket-engaging features 16 and is radially distributed about the disk-shaped structure with radially alternating pole configurations.

Although the invention has been explained in relation to its preferred embodiment, it is to be understood that many other possible modifications and variations can be made without departing from the spirit and scope of the invention as hereinafter claimed.

What is claimed is:

1. A socket holding device comprises:
a planar housing;
an at least one socket-attachment mechanism;
the socket-attachment mechanism comprises an at least one magnet and an at least one socket-engaging feature;
the socket-attachment mechanism being integrated into the planar housing;
the magnet extending from a first end of the planar housing to a second end of the planar housing;
the magnet being internally mounted within the planar housing;
the socket-engaging feature being positioned adjacent to a top surface of the planar housing; and
the socket-engaging features being integrated into the planar housing.

2. The socket holding device as claimed in claim 1 comprises:
the at least one magnet comprises an at least one magnet assembly;
the magnet assembly comprises a plurality of first magnets and a plurality of second magnets;
a north pole for each within the plurality of first magnets being oriented towards the top surface;
a south pole for each within the plurality of second magnets bring oriented towards the top surface;
the plurality of first magnets and the plurality of second magnets being distributed along the planar housing from the first end to the second end; and
the plurality of first magnets being interspersed amongst the plurality of second magnets.

3. The socket holding device as claimed in claim 2 comprises:
the at least one magnet assembly comprises a first magnet assembly and a second magnet assembly;
the first magnet assembly and the second magnet assembly being positioned offset to each other; and
the socket-engaging feature being positioned in between the first magnet assembly and the second magnet assembly.

4. The socket holding device as claimed in claim 1 comprises:
the at least one magnet comprises a first continuous magnet and a second continuous magnet;
the first continuous magnet and the second continuous magnet are positioned offset to each other; and
the socket-engaging feature being positioned in between the first continuous magnet and the second continuous magnet.

5. The socket holding device as claimed in claim 1 comprises:
the at least one socket-attachment mechanism comprises a plurality of socket-attachment mechanisms; and
the plurality of socket-attachment mechanism being distributed about the planar housing from a first lateral sidewall of the planar housing to a second lateral sidewall of the planar housing.

6. The socket holding device as claimed in claim 1 comprises:
a plurality of first gripping features;
the plurality of first gripping features extending from the first end to the second end;
the plurality of first gripping features being positioned adjacent to a first lateral sidewall of the of the planar housing; and
each of the plurality of first gripping features being integrated into the planar housing.

7. The socket holding device as claimed in claim 1 comprises:
a plurality of second gripping features;
the plurality of second gripping features extending from the first end to the second end;
the plurality of second gripping features being positioned adjacent to a second lateral sidewall of the of the planar housing; and
each of the plurality of second gripping features being integrated into the planar housing.

8. The socket holding device as claimed in claim 1 comprises:
the socket-engaging feature being a recessed region; and
the recessed region normally traversing into the planar housing from the top surface.

9. The socket holding device as claimed in claim 8, wherein the recessed region extends along the planar housing;

10. The socket holding device as claimed in claim 1 comprises:
a first handle;
the first handle being positioned adjacent to the first end of the planar housing; and
the first handle being laterally and pivotably mounted to the planar housing.

11. The socket holding device as claimed in claim 1 comprises:
a second handle;
the second handle is positioned adjacent to the second end of the planar housing; and
the second handle being laterally and pivotably mounted to the planar housing.

12. The socket holding device as claimed in claim 1 comprises:
the socket-engaging feature comprises a stud and a dome;
the stud being oriented normal to the top surface;
the stud being adjacent connected to the top surface;
the dome being positioned adjacent to the stud, opposite the planar housing; and
the dome being concentrically and terminally connected to the stud.

13. The socket holding device as claimed in claim 1 comprises:
the at least one magnet comprises an at least one magnet assembly;
the magnet assembly comprises a plurality of third magnets and a plurality of fourth magnets;
the plurality of third magnets and the plurality of fourth magnets being distributed along the planar housing from the first end to the second end;
a north pole for each within the plurality of third magnets being oriented towards a first lateral sidewall;
a north pole for each within the plurality of fourth magnets bring oriented towards a second lateral sidewall; and
the plurality of third magnets being interspersed amongst the plurality of fourth magnets.

14. The socket holding device as claimed in claim 1 comprises:
the at least one socket-engaging feature being a plurality of socket-engaging features; and
the plurality of socket-engaging features being distributed along the magnet.
